(19) United States
(12) Patent Application Publication
(10) Pub. No.: US 2025/0300227 A1
(43) Pub. Date: Sep. 25, 2025

(54) ELECTROLYTE OF RECHARGEABLE LITHIUM BATTERY AND RECHARGEABLE LITHIUM BATTERY INCLUDING SAME

(71) Applicant: SAMSUNG SDI CO., LTD., Gyeonggi-do (KR)

(72) Inventors: Minseo KIM, Gyeonggi-do (KR); Myungheui WOO, Gyeonggi-do (KR); Sanghoon KIM, Gyeonggi-do (KR); Arum YU, Gyeonggi-do (KR)

(73) Assignee: SAMSUNG SDI CO., LTD., Gyeonggi-do (KR)

(21) Appl. No.: 18/860,791

(22) PCT Filed: Nov. 9, 2022
(86) PCT No.: PCT/KR2022/017590

§ 371 Date: Oct. 28, 2024

(30) Foreign Application Priority Data
May 20, 2022 (KR) 10-2022-0061881

(51) Int. Cl. H01M 10/0567; H01M 10/0525; H01M 10/0568

(52) U.S. Cl. CPC H01M 10/0567; H01M 10/0568; H01M 10/0525

(57) ABSTRACT

The present invention relates to an electrolyte of a rechargeable lithium battery and a rechargeable lithium battery including same, and the electrolyte including a non-aqueous organic solvent; a lithium salt; an ionic liquid including a cation and an anion.

### TECHNICAL FIELD

This relates to an electrolyte for a rechargeable lithium battery and a rechargeable lithium battery including the same.

### BACKGROUND ART

A portable information device such as a cell phone, a laptop, a smart phone, and the like or an electric vehicle has used a rechargeable lithium battery having high energy density and easy portability as a driving power source.

In general, a rechargeable lithium battery is manufactured by using materials capable of reversibly intercalating and deintercalating lithium ions as a positive active material and a negative active material and filling an electrolyte between the positive electrode and the negative electrode.

Lithium-transition metal oxides are used as the positive active material of the rechargeable lithium battery, various types of carbon-based materials are used as the negative active material, and lithium salts dissolved in the non-aqueous organic solvent are used as an electrolyte.

In particular, as a rechargeable lithium battery exhibits battery characteristics by complex reactions such as a positive electrode and an electrolyte, a negative electrode, and an electrolyte, and the like, the use of a suitable electrolyte is one of important parameters for improving the performance of a rechargeable lithium battery.

### Technical Problem

One embodiment provides an electrolyte for a rechargeable lithium battery exhibiting excellent thermal safety, while the performances of the battery are maintained.

Another embodiment provides a rechargeable lithium battery including the electrolyte.

### Technical Solution

An electrolyte for a rechargeable lithium battery may include a non-aqueous organic solvent; a lithium salt; an ionic liquid including a cation represented by Chemical Formula 1 and an anion represented by Chemical Formula 2, and an additive including at least one of compounds represented by Chemical Formulas 3 to 6.

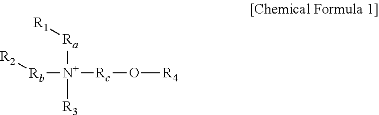

(wherein, R₁ to R₄ are the same or different, and are a substituted or unsubstituted C₁ to C₃ alkyl group, and
Rₐ, R_{b}, R_{c}, and R_{d} are the same or different, and are a substituted or unsubstituted C₁ to C₆ alkylene group.)

R₅—SO₂—N⁻—SO₂—R₆ [Chemical Formula 2]
(wherein, R₅ and R₆ are a fluoroalkyl group including at least one F.)

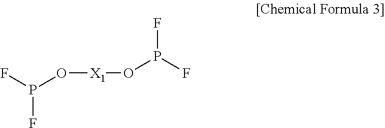

(wherein, X₁ is a substituted or unsubstituted C1 to C3 alkylene group or (—C₂H₄—O—C₂H₄—)ₙ₁, and n1 is an integer ranging from 1 to 10.)

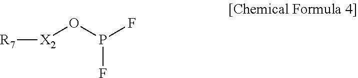

(wherein, X₂ is a substituted or unsubstituted C1 to C2 alkylene group or or (—C₂H₄—O—C₂H₄—)ₙ₂, and n₂ is an integer ranging from 1 to 10, and
R₇ is —CN, —N═C═O, —N═C═S, —OSO₂CH₃, —OSO₂C₂H₅, —OSO₂F, or —OSO₂CF₃.)

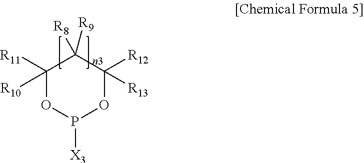

(wherein,
X₃ is a fluoro group, a chloro group, a bromo group, or an iodo group,
R₈ to R₁₃ are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and
n₃ is an integer of 0 or 1.)

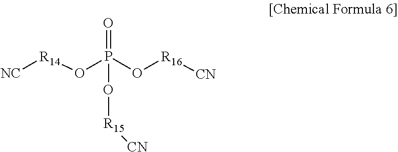

(wherein, R₁₄ to R₁₆ are the same or different, and are a substituted or unsubstituted C1 to C10 alkylene group, a substituted or unsubstituted C3 to C30 cycloalkylene group, a substituted or unsubstituted C6 to C30 arylene group, or a substituted or unsubstituted C2 to C30 heteroarylene group.)

An amount of the ionic liquid may be 0.05 wt % to 30 wt % based on the total, 100 wt %, of the electrolyte.

An amount of the additive may be 0.05 wt % to 10 wt %, or 0.05 wt % to 8 wt %, based on the total, 100 wt %, of the electrolyte.

According to one embodiment, in Chemical Formula 4, R₇ may be —CN, and in Chemical Formula 5, X₃may be F.

Furthermore, the compound of Chemical Formula 5 may be represented by Chemical Formula 5a or Chemical Formula 5b.

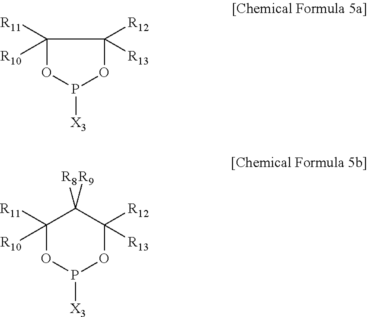

(wherein,
X₃ is a fluoro group, a chloro group, a bromo group, or an iodo group, and
R₈ to R₁₃ are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.)

A rechargeable lithium battery according to one embodiment may include a negative electrode, a positive electrode, and an electrolyte.

### Advantageous Effects

An electrolyte for a rechargeable lithium battery according to one embodiment may realize a rechargeable lithium battery exhibiting improved thermal safety, while the electrical characteristics may be maintained.

### BRIEF DESCRIPTION OF THE DRAWINGS

FIG. 1 is a schematic view of a rechargeable lithium battery according to an embodiment.

### MODE FOR INVENTION

Hereinafter, the present invention will be described more fully hereinafter with reference to the accompanying drawings, in which exemplary embodiments of the invention are shown. The present invention may be embodied in many different forms and is not construed as limited to the example embodiments set forth herein.

In order to clearly illustrate the present invention, parts that are not related to the description are omitted, and the same or similar components are denoted by the same reference numerals throughout the specification.

Furthermore, sizes and thicknesses of components in the drawings are arbitrarily expressed for convenience of description and, thus the present invention is not limited by the drawings.

In addition, unless explicitly described to the contrary, the word “comprise”, and variations such as “comprises” or “comprising”, will be understood to imply the inclusion of stated elements but not the exclusion of any other elements.

As used herein, when a definition is not otherwise provided, the term ‘substituted’ refers to one in which hydrogen of a compound is substituted with a halogen atom (F, Br, C1 or I), a hydroxy group, an alkoxy group, a nitro group, a cyano group, an amino group, an azido group, an amidino group, a hydrazine group, a hydrazono group, a carbonyl group, a carbamyl group, a thiol group, an ester group, a carboxyl group or a salt thereof, a sulfonic acid group or a salt thereof, phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

In the specification, when a definition is not otherwise provided, the term, ‘hetero’ refers to one including 1 to 3 heteroatoms selected from N, O, S, and P.

An electrolyte for a rechargeable lithium battery according to one embodiment may include a non-aqueous organic solvent, a lithium salt, an ionic liquid including a cation and an anion, and an additive.

The ionic liquid may include a cation represented by Chemical Formula 1 and an anion represented by Chemical Formula 2.

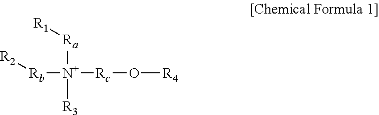

In Chemical Formula 1, R₁ to R₄ are the same or different and are a substituted or unsubstituted C1 to C3 alkyl group, and
Rₐ, R_{b}, R_{c}, and R_{d} are the same or different, and are a substituted or unsubstituted C1 to C6 alkylene group.

The R₁ to R₄ are the same or different, and are an unsubstituted C1 to C3 alkyl group, and the Rₐ, R_{b}, R_{c}, and R_{d} are the same or different, and are an unsubstituted C1 to C6 alkylene group.

R₅—SO₂—N⁻—SO₂—R₆ [Chemical Formula 2]

In Chemical Formula 2, R₅ and R₆ are a fluoroalkyl group including at least one F. The fluoroalkyl group may include a C1 to C3 alkyl group, and one to three F. The example of the fluoroalkyl group may be —CFH₂, —CF₂H, or —CF₃.

The additive according to one embodiment may be at least one of compounds represented by Chemical Formulas 3 to 6.

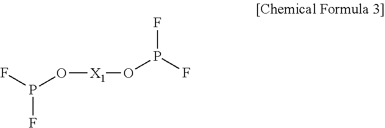

In Chemical Formula 3, X₁ is a substituted or unsubstituted C1 to C3 alkylene group, or (—C₂H₄—O—C₂H₄—)ₙ₁, and n1 is an integer ranging from 1 to 10. The X₁ may be an unsubstituted C1 to C3 alkylene group.

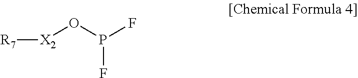

In Chemical Formula 4, X₂ is a substituted or unsubstituted C1 to C2 alkylene group, or (—C₂H₄—O—C₂H₄—)ₙ₂, and n₂ is an integer ranging from 1 to 10, and
R₇ is —CN, —N═C═O, —N═C═S, —OSO₂CH₃, —OSO₂C₂H₅, —OSO₂F, or —OSO₂CF₃. In one embodiment, the X₂ may be a substituted or unsubstituted C₁ to C₂ alkylene group, and the R₇ may be —CN.

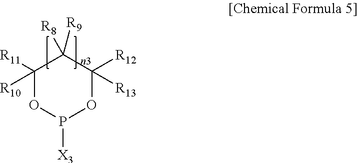

In Chemical Formula 5,
X₃ is a fluoro group, a chloro group, a bromo group, or an iodo group,
R₈ to R₁₃ are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and n₃ is an integer of 0 or 1.

The X₃ may be F, and the R₈ to R₁₃ may be hydrogen.

The compound of Chemical Formula 5 may be represented by Chemical Formula 5a or Chemical Formula 5b.

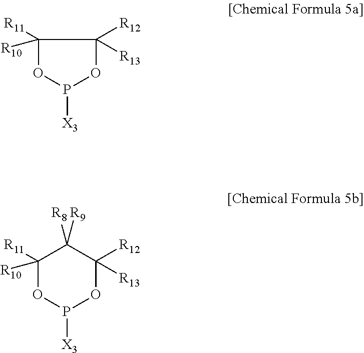

In Chemical Formula 5a or Chemical Formula 5b,
X₃ is a fluoro group, a chloro group, a bromo group, or an iodo group, and
R₈ to R₁₃ are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

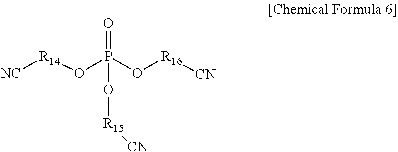

In Chemical Formula 6,
R₁₄ to R₁₆ are the same or different, and are a substituted or unsubstituted C1 to C10 alkylene group, a substituted or unsubstituted C3 to C30 cycloalkylene group, a substituted or unsubstituted C6 to C30 arylene group, or a substituted or unsubstituted C2 to C30 heteroarylene group.

R₁₄ to R₁₆ are the same or different, and may be an unsubstituted C1 to C10 alkylene group.

As such, the electrolyte for the rechargeable lithium battery includes at least one additive of the compounds represented by Chemical Formulas 3 to 6, together with the ionic liquid including a cation of Chemical Formula 1 and an anion of Chemical Formula 2.

In one embodiment, the inclusion of the ionic liquid may render to improve the overcharge safety and thermal safety, and the inclusion of the additive may allow to improve the cycle-life characteristics, particularly room temperature cycle-life characteristics, and improve thermal safety such as decreases in self-extinguishing time and heating value.

The effect by using the ionic liquid together with the additive may be realized from using the ionic liquid including the cation of Chemical Formula 1 and the anion of Chemical Formula 2, together with at least one additive of compounds represented by Chemical Formulas 3 to 6. The thermal safety effect may be not obtained if the cation of Chemical Formula 1 and the anion of Chemical Formula 2 are not included, even if the ionic liquid is used.

In one embodiment, an amount of the ionic liquid may be 0.05 wt % to 30 wt % based on the total, 100 wt %, of the electrolyte. According to another embodiment, the amount of the ionic liquid may be 1 wt % to 30 wt %, 2 wt % to 30 wt %, 2 wt % to 20 wt %, or 2 wt % to 10 wt %. When the amount of the ionic liquid is within the range, the effect for improving the thermal safety may be more sufficiently obtained.

An amount of the additive may be 0.05 wt % to 10 wt %, 0.05 wt % to 8 wt %, or 0.05 wt % to 5 wt % based on the total, 100 wt %, of the electrolyte. When the amount of the additive satisfies the range, the thermal safety may be more improved, while the battery characteristics are maintained.

In one embodiment, the ionic liquid and the additive may be presented at a weight ratio of 2:1 to 20:1, and the thermal safety may be more improved in the above range.

The cation represented by Chemical Formula 1 may be represented by Chemical Formula 1-1, and the anion represented by Chemical Formula 2 may be represented by Chemical Formula 2-1.

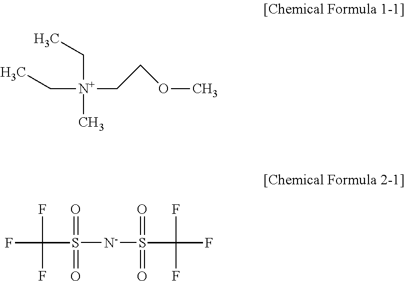

The ionic liquid according to one embodiment may be diethyl methyl (2-methoxyethyl)ammonium bis(trifluoromethylsulfonyl)imide).

The compound represented by Chemical Formula 3 may be ethane-1,2-diyl bis(phosphorodifluoridoite).

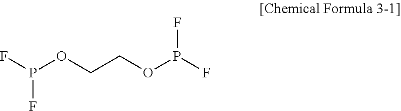

The compound represented by Chemical Formula 4 may be 2-cyanoethyl phosphorodifluoridoite represented by Chemical Formula 4-1.

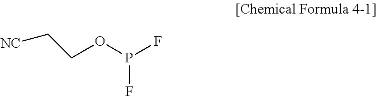

The compound represented by Chemical Formula 5 may be 2-fluoro-1,3,2-dioxaphospholane represented by Chemical Formula 5-1, or 2-fluoro-4-methyl-1,3,2-dioxaphospholane represented by Chemical Formula 5-2.

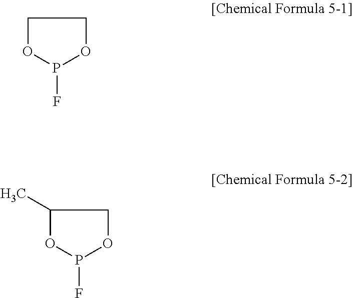

The compound represented by Chemical Formula 6 may be the cyanoalkyl phosphate represented by Chemical Formula 6-1.

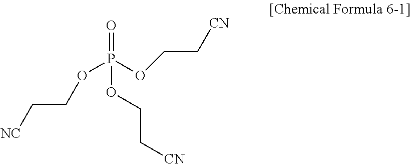 [SMILES: N#CCCOP(=O)(OCCC#N)OCCC#N]

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, dimethyl acetate, methyl propionate, ethyl propionate, y-butyrolactone, decanolide, valerolactone, mevalonolactone, caprolactone and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like.

Furthermore, the alcohol-based solvent may include ethyl alcohol, isopropyl alcohol, and the like, and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The organic solvent may be used alone or in a mixture, and when the organic solvent is used in a mixture, the mixture ratio may be controlled in accordance with a desirable battery performance and it may be well known to one in the related art.

When the non-aqueous organic solvents are mixed and used, a mixed solvent of a cyclic carbonate and a linear carbonate, a mixed solvent of a cyclic carbonate and a propionate-based solvent, or a mixed solvent of a cyclic carbonate, a linear carbonate, and a propionate-based solvent may be used. The propionate-based solvent may be methyl propionate, ethyl propionate, propyl propionate, or a combination thereof.

Herein, when a mixture of a cyclic carbonate and a linear carbonate, or a mixture of cyclic carbonate and a propionate-based solvent is used, it may be desirable to use it with a volume ratio of about 1:1 to about 1:9 considering the performances. Furthermore, the cyclic carbonate, the linear carbonate, and the propionate-based solvent may be mixed and used at a volume ratio of 1:1:1 to 3:3:4. The mixing ratio of the solvents may also be suitably controlled depending on the desired performances.

The organic solvent may further include an aromatic hydrocarbon-based solvent as well as the carbonate-based solvent. Herein, the carbonate-based solvent and the aromatic hydrocarbon-based solvent may be mixed together in a volume ratio of 1:1 to 30:1.

The aromatic hydrocarbon-based organic solvent may be an aromatic hydrocarbon-based compound represented by Chemical Formula 7.

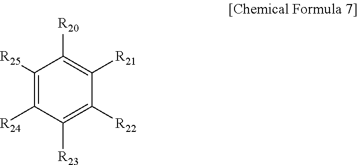

(In Chemical Formula 1, R₁ to R₆ are the same or different and are selected from hydrogen, a halogen, a C1 to C10 alkyl group, a haloalkyl group, and a combination thereof.)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinyl ethyl carbonate, vinylene carbonate, or an ethylene carbonate-based compound represented by Chemical Formula 8, as an additive for improving cycle life.

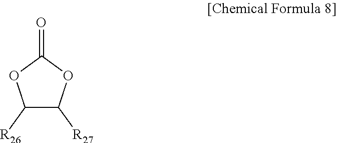

(In Chemical Formula 8, R₂₆ and R₂₇ are the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.)

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. An amount of the additive for improving the cycle-life characteristics may be used within an appropriate range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts selected from LiPF₆, LiBF₄, LiSbF₆, LiAsF₆, LiN(SO₂C₂F₅)₂, Li(CF₃SO₂)₂N, LiN (SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of 1 to 20), lithium difluoro(bisoxolato) phosphate), LiCl, LiI, LiB(C₂O₄)₂ (lithium bis(oxalato)borate: LiBOB), and lithium difluoro(oxalato)borate (LiDFOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

Another embodiment provides a rechargeable lithium battery including the non-aqueous electrolyte.

The rechargeable lithium battery includes the non-aqueous electrolyte, a negative electrode, and a positive electrode.

In one embodiment the negative electrode includes a negative active material layer including a negative active material and a current collector supported on the negative active material layer.

The negative active material includes a material that reversibly intercalates/deintercalates lithium ions, a lithium metal, a lithium metal alloy, a material capable of doping/dedoping lithium or transition metal oxide.

The material that reversibly intercalates/deintercalates lithium ions may be a carbon material that may be any generally-used carbon-based negative active material used in a rechargeable lithium battery. Examples thereof may be crystalline carbon, amorphous carbon, or a combination thereof. The crystalline carbon may be shapeless (unspecified shape), or may be sheet, flake, spherical, or fiber shaped natural graphite or artificial graphite, and the amorphous carbon may be soft carbon or hard carbon, a mesophase pitch carbonized product, fired cokes, and the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and not Si), Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, and not Sn), and the like, and at least one of these materials may be mixed with SiO₂. The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition element oxide may be a lithium titanium oxide.

The negative active material according to one embodiment may include a Si-C composite including a Si-based active material and a carbon-based active material.

The Si-based active material is Si, SiOₓ (0<x<2), or a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof thereof, and not Si).

An average particle diameter of the Si-based active material may be 50 nm to 200 nm.

When the particle diameter of the Si particle is within the range, the volume expansion caused during charge and discharge may be suppressed, and breakage of the conductive path due to crushing of particles may be prevented.

The Si-based active material may be included in an amount of 1 wt % to 60 wt % based on the total weight of the Si—C composite, and for example, 3 wt % to 60 wt %.

The negative active material according to another embodiment may further include a crystalline carbon in addition to the Si—C composite.

If the negative active material includes both the Si—C composite and crystalline carbon, the Si—C composite and the crystalline carbon may be included in the form of a mixture, and herein, the Si—C composite and the crystalline carbon may be included at a weight ratio of 1:99 to 50:50. More specifically, the Si—C composite and the crystalline carbon may be included in a weight ratio of 5:95 to 20:80.

The crystalline carbon, may, for example, include graphite, and more specifically, may include natural graphite, artificial graphite, or mixture thereof.

The crystalline carbon may have an average particle diameter of 5 μm to 30 μm.

In the specification, the average a particle diameter refers to a particle size (D50) where a cumulative volume is 50 volume % in a cumulative size-distribution curve.

The Si—C composite may further include a shell surrounded on a surface of the Si—C composite, and the shell may include amorphous carbon. A thickness of the shell may be 5 nm to 100 nm.

The amorphous carbon may be soft carbon, hard carbon, mesophase pitch carbide, a sintered coke, or a mixture thereof.

The amorphous carbon may be included at an amount of 1 part by weight to 50 parts by weight based on 100 parts by weight of the carbon-based active material, for example, 5 parts by weight to 50 parts by weight, or 10 parts by weight to 50 parts by weight.

The negative active material layer may include a binder, and optionally a conductive material.

In the negative active material layer, an amount of the negative active material may be about 95 wt % to about 99 wt % based on the total weight of the negative active material layer. In the negative active material layer, an amount of the binder may be 1 wt % to 5 wt % based on the total weight of the negative active material layer. Furthermore, in case of further including the conductive material, the negative active material may be included in an amount of 90 wt % to 98 wt %, the binder may be included in an amount of 1 wt % to 5 wt %, and the conductive material may be included in an amount of 1 wt % to 5 wt %.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include a styrene-butadiene rubber, an acrylated styrene-butadiene rubber, an acrylonitrile-butadiene rubber, an acrylic rubber, a butyl rubber, a fluorine rubber, an ethylene oxide-containing polymer, polyvinylpyrrolidone, polyepichlorohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is used as a negative electrode binder, a cellulose-based compound may be further used to provide viscosity as a thickener. The cellulose-based compound includes one or more of carboxymethyl cellulose, hydroxypropyl methyl cellulose, methyl cellulose, or alkali metal salts thereof. The alkali metal may be Na, K, or Li. The thickener may be included in an amount of about 0.1 parts by weight to about 3 parts by weight based on 100 parts by weight of the negative active material.

The conductive material is included to provide electrode conductivity, and any electrically conductive material may be used as a conductive material unless it causes a chemical change. Examples of the conductive material may be a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The positive electrode includes a positive active material layer including a positive active material layer and a current collector supported on the positive active material layer.

The positive electrode active material may include lithiated intercalation compounds that reversibly intercalate and deintercalate lithium ions, and specifically, one or more composite oxides of a metal selected from cobalt, manganese, nickel, and a combination thereof, and lithium, may be used. More specifically, the compounds represented by one of the following chemical formulae may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0<b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂ PO₄₃ (0≤f≤2); Li_{(3-f)}Fe₂ PO₄₃ (0≤f≤2); LiₐFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail since it is well-known in the related field.

In the positive electrode, an amount of the positive active material may be about 90 wt % to about 98 wt % based on the total weight of the positive active material layer.

In one embodiment, the positive active material layer may further include a binder and a conductive material. Herein, the amount of the binder and the conductive material may be 1 wt % to 5 wt %, respectively, based on the total amount of the positive active material layer.

The binder improves binding properties of positive electrode active material particles with one another and with a current collector, and examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and the like, but are not limited thereto.

The conductive material is included to provide electrode conductivity, and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may use aluminum foil, a nickel foil, or a combination thereof, but is not limited thereto.

The positive active material layer and the negative active material layer may be formed by mixing an active material, binder, and optionally a conductive material, in a solvent to prepare an active material composition, and coating the active material composition on a current collector. Such an active material layer preparation method is well known and thus is not described in detail in the present specification. The solvent includes N-methylpyrrolidone and the like, but is not limited thereto. In addition, when the binder is a water-soluble binder, the solvent may be water.

Furthermore, a separator may be disposed between the positive electrode and the negative electrode depending on a type of a rechargeable lithium battery. The separator may use polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and the like.

The separator may also include a porous substrate and a ceramic-included coating layer positioned on one side of the porous substrate. The ceramic may include SiO₂, Al₂O₃, Al(OH)₃, AlO(OH), TiO₂, BaTiO₂, ZnO₂, Mg(OH)₂, MgO, Ti(OH)₄, ZrO₂, aluminum nitride, silicon carbide, boron nitride, or a combination thereof.

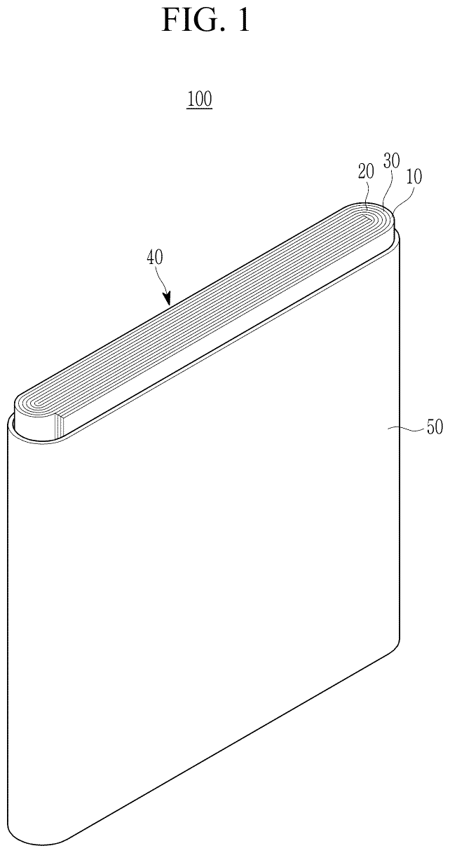

FIG. 1 is an exploded perspective view of a rechargeable lithium battery according to an embodiment of the present invention. The rechargeable lithium battery according to an embodiment is illustrated as a pouch battery, but is not limited thereto, and may include variously-shaped batteries such as a cylindrical battery and a prismatic pouch battery.

Referring to FIG. 1, a rechargeable lithium battery 100 according to an embodiment includes: a battery assembly including a positive electrode 114, a negative electrode 112 facing the positive electrode 114, a separator 113 disposed between the positive electrode 114 and the negative electrode 112, and an electrolyte (not shown) in which the positive electrode 114, the negative electrode 112, and the separator 113 are immersed; a battery case 120 housing the battery assembly; and a sealing member 140 sealing the battery case 120.

### DETAILED DESCRIPTION OF THE INVENTION

Hereinafter, examples of the present invention and comparative examples are described. These examples, however, are not in any sense to be interpreted as limiting the scope of the invention.

### Comparative Example 1

### (1) Preparation of Electrolyte

1.5 M of LiPF₆ was dissolved in a non-aqueous organic solvent in which ethylene carbonate, ethyl methyl carbonate, and dimethyl carbonate were mixed in a volume % of 20:10:70 to prepare an electrolyte for a rechargeable lithium cell.

### (2) Preparation of Positive Electrode and Negative Electrode

98 wt % of a LiNi_{0.8}Co_{0.1}Mn_{0.1}O₂ positive active material, 1 wt % of a polyvinylidene fluoride binder, and 1 wt % of a ketjen black conductive material were mixed in a N-methyl pyrrolidone solvent to prepare a positive active material slurry. The positive active material slurry was coated on an aluminum foil and dried followed by pressurizing to prepare a positive electrode.

97 wt % of an artificial graphite negative active material, 1 wt % of a ketjen black conductive material, 1 wt % of a styrene-butadiene rubber binder, and 1 wt % of a carboxymethyl cellulose thickener were mixed in a distilled water solvent to prepare a negative active material slurry. The negative active material slurry was coated on a copper foil and dried followed by pressurizing to prepare a negative electrode.

Using the electrolyte, the positive electrode, and the negative electrode, an 18650 cylindrical rechargeable lithium cell was fabricated according to the conventional procedure.

### Comparative Example 2

1.5 M of LiPF₆ was dissolved in a non-aqueous organic solvent in which ethylene carbonate, ethyl methyl carbonate, and dimethyl carbonate were mixed in a volume % of 20:10:70 to prepare an electrolyte precursor.

An ionic liquid including a cation of Chemical Formula 1-1 and an anion of Chemical Formula 2-1 was added to the electrolyte precursor to prepare an electrolyte for a rechargeable lithium cell. Herein, an amount of the ionic liquid was set to be 10 wt % based on the total, 100 wt %, of the electrolyte.

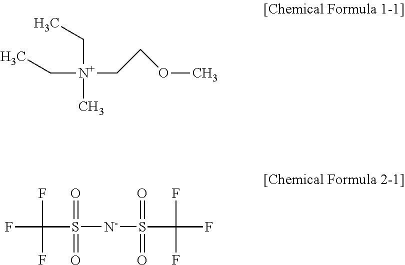

Using the electrolyte, the positive electrode of Comparative Example 1, and the negative electrode of Comparative Example 1, an 18650 cylindrical rechargeable lithium cell was fabricated according to the conventional procedure.

### Comparative Example 3

An ionic liquid including a cation of Chemical Formula 1-1 and a BF₄⁻ anion, and an additive of Chemical Formula 3-1, were added to the electrolyte precursor of Comparative Example 2 to prepare an electrolyte for a rechargeable lithium cell. Herein, an amount of the ionic liquid was set to be 10 wt % based on the total, 100 wt %, of the electrolyte, and the amount of the additive was set to be 1 wt % based on the total, 100 wt %, of the electrolyte.

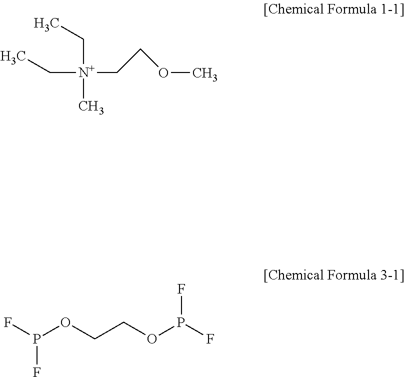

Using the electrolyte, the positive electrode of Comparative Example 1, and the negative electrode of Comparative Example 1, an 18650 cylindrical rechargeable lithium cell was fabricated according to the conventional procedure.

### Comparative Example 4

An ionic liquid including a triethyl sulfonium cation and an anion of Chemical Formula 2-1, and an additive of Chemical Formula 3-1, were added to the electrolyte precursor of Comparative Example 2 to prepare an electrolyte for a rechargeable lithium cell. Herein, an amount of the ionic liquid was set to be 10 wt % based on the total, 100 wt %, of the electrolyte, and the amount of the additive was set to be 1 wt % based on the total, 100 wt %, of the electrolyte.

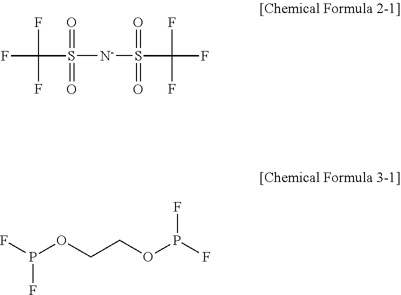 [SMILES: O=S(=O)([N-]S(=O)(=O)C(F)(F)F)C(F)(F)F ; FP(F)OCCOP(F)F]

Using the electrolyte, the positive electrode of Comparative Example 1, and the negative electrode of Comparative Example 1, an 18650 cylindrical rechargeable lithium cell was fabricated according to the conventional procedure.

### Comparative Example 5

An additive of Chemical Formula 3-1 was added to the electrolyte precursor of Comparative Example 2 to prepare an electrolyte for a rechargeable lithium cell. Herein, an amount of the additive was set to be 10 wt % based on the total, 100 wt %, of the electrolyte.

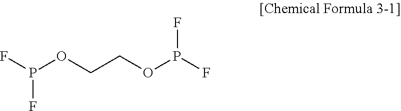

Using the electrolyte, the positive electrode of Comparative Example 1, and the negative electrode of Comparative Example 1, an 18650 cylindrical rechargeable lithium cell was fabricated according to the conventional procedure.

### Comparative Example 6

An additive of Chemical Formula 4-1 was added to the electrolyte precursor of Comparative Example 2 to prepare an electrolyte for a rechargeable lithium cell. Herein, an amount of the additive was set to be 0.5 wt % based on the total, 100 wt %, of the electrolyte.

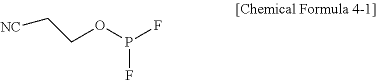

Using the electrolyte, the positive electrode of Comparative Example 1, and the negative electrode of Comparative Example 1, an 18650 cylindrical rechargeable lithium cell was fabricated according to the conventional procedure.

### Comparative Example 7

An additive of Chemical Formula 5-1 was added to the electrolyte precursor of Comparative Example 2 to prepare an electrolyte for a rechargeable lithium cell. Herein, an amount of the additive was set to be 0.5 wt % based on the total, 100 wt %, of the electrolyte.

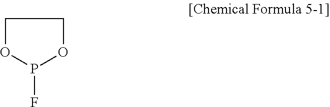

Using the electrolyte, the positive electrode of Comparative Example 1, and the negative electrode of Comparative Example 1, an 18650 cylindrical rechargeable lithium cell was fabricated according to the conventional procedure.

### Comparative Example 8

An additive of Chemical Formula 5-2 was added to the electrolyte precursor of Comparative Example 2 to prepare an electrolyte for a rechargeable lithium cell. Herein, an amount of the additive was set to be 0.75 wt % based on the total, 100 wt %, of the electrolyte.

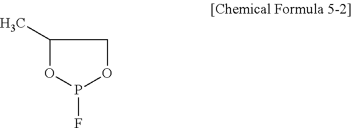

Using the electrolyte, the positive electrode of Comparative Example 1, and the negative electrode of Comparative Example 1, an 18650 cylindrical rechargeable lithium cell was fabricated according to the conventional procedure.

### Comparative Example 9

An additive of Chemical Formula 6-1 was added to the electrolyte precursor of Comparative Example 2 to prepare an electrolyte for a rechargeable lithium cell. Herein, an amount of the additive was set to be 0.5 wt % based on the total, 100 wt %, of the electrolyte.

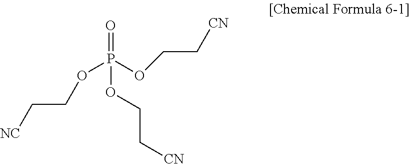 [SMILES: N#CCCOP(=O)(OCCC#N)OCCC#N]

Using the electrolyte, the positive electrode of Comparative Example 1, and the negative electrode of Comparative Example 1, an 18650 cylindrical rechargeable lithium cell was fabricated according to the conventional procedure.

### Example 1

An ionic liquid used in Comparative Example 2 and an additive of Chemical Formula 3-1 were added to the electrolyte precursor of Comparative Example 2 to prepare an electrolyte for a rechargeable lithium cell. Herein, an amount of the ionic liquid was set to be 2 wt % based on the total, 100 wt %, of the electrolyte, and the amount of the additive was set to be 0.5 wt % based on the total, 100 wt %, of the electrolyte.

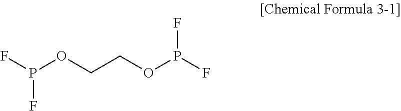

Using the electrolyte, the positive electrode of Comparative Example 1, and the negative electrode of Comparative Example 1, an 18650 cylindrical rechargeable lithium cell was fabricated according to the conventional procedure.

### Example 2

An electrolyte was prepared by the same procedure as in Example 1, except that the ionic liquid was set to be 10 wt % based on the total, 100 wt %, of the electrolyte, and the additive was set to be 0.5 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 3

An electrolyte was prepared by the same procedure as in Example 1, except that the ionic liquid was set to be 2 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 4

An electrolyte was prepared by the same procedure as in Example 1, except that the ionic liquid was set to be 10 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 5

An ionic liquid used in Example 1 and an additive of Chemical Formula 4-1 were added to the electrolyte precursor of Comparative Example 2 to prepare an electrolyte for a rechargeable lithium cell. Herein, an amount of the ionic liquid was set to be 2 wt % based on the total, 100 wt %, of the electrolyte, and the amount of the additive was set to be 0.5 wt % based on the total, 100 wt %, of the electrolyte.

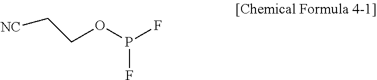

Using the electrolyte, the positive electrode of Comparative Example 1, and the negative electrode of Comparative Example 1, an 18650 cylindrical rechargeable lithium cell was fabricated according to the conventional procedure.

### Example 6

An electrolyte was prepared by the same procedure as in Example 5, except that the ionic liquid was set to be 10 wt % based on the total, 100 wt %, of the electrolyte, and the additive was set to be 0.5 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 7

An electrolyte was prepared by the same procedure as in Example 5, except that the ionic liquid was set to be 2 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 8

An electrolyte was prepared by the same procedure as in Example 5, except that the ionic liquid was set to be 10 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 9

An ionic liquid used in Example 1 and an additive of Chemical Formula 5-1 were added to the electrolyte precursor of Comparative Example 2 to prepare an electrolyte for a rechargeable lithium cell. Herein, an amount of the ionic liquid was set to be 2 wt % based on the total, 100 wt %, of the electrolyte, and the amount of the additive was set to be 0.5 wt % based on the total, 100 wt %, of the electrolyte.

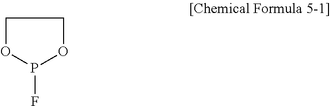

Using the electrolyte, the positive electrode of Comparative Example 1, and the negative electrode of Comparative Example 1, an 18650 cylindrical rechargeable lithium cell was fabricated according to the conventional procedure.

### Example 10

An electrolyte was prepared by the same procedure as in Example 9, except that the ionic liquid was set to be 10 wt % based on the total, 100 wt %, of the electrolyte, and the additive was set to be 0.5 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 11

An electrolyte was prepared by the same procedure as in Example 9, except that the ionic liquid was set to be 2 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 12

An electrolyte was prepared by the same procedure as in Example 9, except that the ionic liquid was set to be 10 wt % based on the total, 100 wt %, of the electrolyte, and the additive was set to be 1 wt % based on the total, 100 wt %, of the electrolyte.

### Example 13

An ionic liquid used in Example 1 and an additive of Chemical Formula 5-2 were added to the electrolyte precursor of Comparative Example 2 to prepare an electrolyte for a rechargeable lithium cell. Herein, an amount of the ionic liquid was set to be 2 wt % based on the total, 100 wt %, of the electrolyte, and the amount of the additive was set to be 0.75 wt % based on the total, 100 wt %, of the electrolyte.

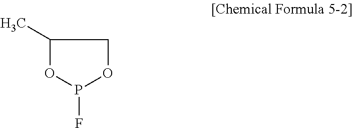

Using the electrolyte, the positive electrode of Comparative Example 1, and the negative electrode of Comparative Example 1, an 18650 cylindrical rechargeable lithium cell was fabricated according to the conventional procedure.

### Example 14

An electrolyte was prepared by the same procedure as in Example 13, except that the ionic liquid was set to be 10 wt % based on the total, 100 wt %, of the electrolyte, and the additive was set to be 0.75 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 15

An electrolyte was prepared by the same procedure as in Example 13, except that the ionic liquid was set to be 2 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 16

An electrolyte was prepared by the same procedure as in Example 13, except that the ionic liquid was set to be 10 wt % based on the total, 100 wt %, of the electrolyte, and the additive was set to be 1 wt % based on the total, 100 wt %, of the electrolyte.

### Example 17

An ionic liquid used in Example 1 and an additive of Chemical Formula 6-1 were added to the electrolyte precursor of Comparative Example 2 to prepare an electrolyte for a rechargeable lithium cell. Herein, an amount of the ionic liquid was set to be 2 wt % based on the total, 100 wt %, of the electrolyte, and the amount of the additive was set to be 0.5 wt % based on the total, 100 wt %, of the electrolyte.

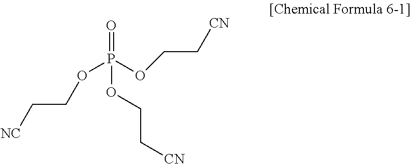 [SMILES: N#CCCOP(=O)(OCCC#N)OCCC#N]

Using the electrolyte, the positive electrode of Comparative Example 1, and the negative electrode of Comparative Example 1, an 18650 cylindrical rechargeable lithium cell was fabricated according to the conventional procedure.

### Example 18

An electrolyte was prepared by the same procedure as in Example 17, except that the ionic liquid was set to be 10 wt % based on the total, 100 wt %, of the electrolyte, and the additive was set to be 0.5 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 19

An electrolyte was prepared by the same procedure as in Example 17, except that the ionic liquid was set to be 2 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

### Example 20

An electrolyte was prepared by the same procedure as in Example 9, except that the ionic liquid was set to be 10 wt % based on the total, 100 wt %, of the electrolyte, and the additive was set to be 1 wt % based on the total, 100 wt %, of the electrolyte.

Using the electrolyte, the positive electrode of Comparative Example 1, and the negative electrode of Comparative Example 1, an 18650 cylindrical rechargeable lithium cell was fabricated according to the conventional procedure.

The compositions of ionic liquid and the additive used in Comparative Examples 1 to 7 and Example 1 to 20 are summarized in Table 1.

TABLE 1

| | Ionic liquid | | | Additive | |
|---|---|---|---|---|---|
| | Type of cation | Type of anion | Amount (wt %) | Type | Amount (wt %) |
| Comparative | — | — | 0 | — | 0 |
| Example 1 | | | | | |
| Comparative | Chemical | Chemical | 10 | — | 0 |
| Example 2 | Formula 1-1 | Formula 2-1 | | | |
| Comparative | Chemical | BF₄⁻ | 10 | Chemical | 1 |
| Example 3 | formula 1-1 | | | Formula 3-1 | |
| Comparative | triethyl | Chemical | 10 | Chemical | 1 |
| Example 4 | sulfonium | Formula 2-1 | | Formula 3-1 | |
| Comparative | — | — | 0 | Chemical | 0.5 |
| Example 5 | | | | Formula 3-1 | |
| Comparative | — | — | 0 | Chemical | 0.5 |
| Example 6 | | | | Formula 4-1 | |
| Comparative | — | — | 0 | Chemical | 0.5 |
| Example 7 | | | | Formula 5-1 | |
| Comparative | — | — | 0 | Chemical | 0.75 |
| Example 8 | | | | Formula 5-2 | |
| Comparative | — | — | 0 | Chemical | 0.5 |
| Example 9 | | | | formula 6-1 | |
| Example 1 | Chemical | Chemical | 2 | Chemical | 0.5 |
| | Formula 1-1 | Formula 2-1 | | Formula 3-1 | |
| Example 2 | Chemical | Chemical | 10 | Chemical | 0.5 |
| | Formula 1-1 | Formula 2-1 | | Formula 3-1 | |
| Example 3 | Chemical | Chemical | 2 | Chemical | 1 |
| | Formula 1-1 | Formula 2-1 | | Formula 3-1 | |
| Example 4 | Chemical | Chemical | 10 | Chemical | 1 |
| | Formula 1-1 | Formula 2-1 | | Formula 3-1 | |
| Example 5 | Chemical | Chemical | 2 | Chemical | 0.5 |
| | Formula 1-1 | Formula 2-1 | | Formula 4-1 | |
| Example 6 | Chemical | Chemical | 10 | Chemical | 0.5 |
| | Formula 1-1 | Formula 2-1 | | Formula 4-1 | |
| Example 7 | chemical | Chemical | 2 | Chemical | 1 |
| | formula 1-1 | Formula 2-1 | | Formula 4-1 | |
| Example 8 | chemical | Chemical | 10 | Chemical | 1 |
| | formula 1-1 | Formula 2-1 | | Formula 4-1 | |
| Example 9 | chemical | Chemical | 2 | Chemical | 0.5 |
| | formula 1-1 | Formula 2-1 | | Formula 5-1 | |
| Example 10 | Chemical | Chemical | 10 | Chemical | 0.5 |
| | Formula 1-1 | Formula 2-1 | | Formula 5-1 | |
| Example 11 | Chemical | Chemical | 2 | Chemical | 1 |
| | Formula 1-1 | Formula 2-1 | | Formula 5-1 | |
| Example 12 | Chemical | Chemical | 10 | Chemical | 1 |
| | Formula 1-1 | Formula 2-1 | | Formula 5-1 | |
| Example 13 | Chemical | Chemical | 2 | Chemical | 0.75 |
| | Formula 1-1 | Formula 2-1 | | Formula 5-2 | |
| Example 14 | Chemical | Chemical | 10 | Chemical | 0.75 |
| | Formula 1-1 | Formula 2-1 | | Formula 5-2 | |
| Example 15 | Chemical | Chemical | 2 | Chemical | 1 |
| | Formula 1-1 | Formula 2-1 | | Formula 5-2 | |
| Example 16 | Chemical | Chemical | 10 | Chemical | 1 |
| | Formula 1-1 | Formula 2-1 | | Formula 5-2 | |
| Example 17 | Chemical | Chemical | 2 | Chemical | 0.5 |
| | Formula 1-1 | Formula 2-1 | | Formula 6-1 | |
| Example 18 | Chemical | Chemical | 10 | Chemical | 0.5 |
| | Formula 1-1 | Formula 2-1 | | Formula 6-1 | |
| Example 19 | Chemical | Chemical | 2 | Chemical | 1 |
| | Formula 1-1 | Formula 2-1 | | Formula 6-1 | |
| Example 20 | Chemical | Chemical | 10 | Chemical | 1 |
| | Formula 1-1 | Formula 2-1 | | Formula 6-1 | |

### Experimental Example 1) Measurement of Room Temperature Capacity Retention

Regarding the rechargeable lithium cells according to Examples 1 to 20 and Comparative Examples 1 to 9, charging and discharging at 0.5 C were performed at room temperature of 25° C. and discharge capacity was measured. Capacity retention at 200 cycles to the 1^{st} discharge capacity was calculated. Among these results, the results of Comparative Examples 1 to 5 and Examples 1 to 4 are shown in Table 2, the results of Comparative Examples 1, 2, and 6 and Examples 5 to 8 are shown in Table 3, and the results of Comparative Examples 1, 2, and 7 and Examples 9 to 12 are shown in Table 4. Furthermore, the results of Comparative Examples 1, 2, and 8 and Examples 13 to 16 are shown in Table 5, and the results of Comparative Examples 1, 2, and 9 and Examples 17 to 20 are shown in Table 6.

### Experimental Example 2) Measurement of Self-Extinguishing Time (SET Time)

The electrolytes prepared according to Examples 1 to 20 and Comparative Examples 1 to 9 were ignited with a torch to measure the self-extinguishing time, and the result are shown as a SET time. Among these results, the results of Comparative Examples 1 to 5 and Examples 1 to 4 are shown in Table 2, the results of Comparative Examples 1, 2, and 6 and Examples 5 to 8 are shown in Table 3, and the results of Comparative Examples 1, 2, and 7 and Examples 9 to 12 are shown in Table 4. Furthermore, the results of Comparative Examples 1, 2, and 8 and Examples 13 to 16 are shown in Table 5, and the results of Comparative Examples 1, 2, and 9, and Examples 17 to 20 are shown in Table 6.

### Experimental Example 3) Measurement of Differential Scanning Calorimetry Analysis (DSC)

The rechargeable lithium cells of Examples 1 to 20 and Comparative Examples 1 to 9 were charged and discharged at 0.2 C and 3.0 V to 4.3 V of a cut-off voltage twice (formation), and then charged at 0.2 C and a 4.3 V cut-off voltage once. The positive electrode was collected from the fully charged cells under an argon atmosphere, and 5 mg of the positive active material was obtained from the positive electrode to measure calorimetry change using a differential scanning calorimetry analysis (DSC) device. The differential scanning calorimetry analysis was measured by increasing a temperature to 400° C. from 40° C. at an increasing rate of 10° C./min.

The calculated heating values (integrated value of the calorific value curve on DSC with respect to temperature) are shown in the tables below. Among these results, the results of Comparative Examples 1 to 5 and Examples 1 to 4 are shown in Table 2, the results of Comparative Examples 1, 2, and 6 and Examples 5 to 8 are shown in Table 3, and the results of Comparative Examples 1, 2, and l and Examples 9 to 12 are shown in Table 4. In addition, the results of Comparative Examples 1, 2, and 8 and Examples 13 to 16 are shown in Table 5, and the results of Comparative Examples 1, 2, and 9 and Examples 17 to 20 are shown in Table 6.

TABLE 2

| | | Amount | Room | | |
|---|---|---|---|---|---|
| | Amount | of additive | temperature | | DSC |
| | of ionic | of Chemical | capacity | SET | heating |
| | liquid | Formula 3-1 | retention | time | value |
| | (wt %) | (wt %) | (%) | (s) | (J/g) |
| Comparative | — | — | 84.2 | 50 | 605 |
| Example 1 | | | | | |
| Comparative | 10 | — | 84.7 | 33 | 510 |
| Example 2 | | | | | |
| Comparative | 10 (BF₄⁻ | 1 | 83.1 | 51 | 606 |
| Example 3 | anion) | | | | |
| Comparative | 10 (sulfoni- | 1 | 83.4 | 50 | 603 |
| Example 4 | um-based | | | | |
| | cation) | | | | |
| Comparative | — | 0.5 | 84.8 | 49 | 604 |
| Example 5 | | | | | |
| Example 1 | 2 | 0.5 | 85.0 | 37 | 530 |
| Example 2 | 10 | 0.5 | 86.6 | 26 | 512 |
| Example 3 | 2 | 1 | 85.2 | 35 | 531 |
| Example 4 | 10 | 1 | 87.3 | 26 | 509 |

As shown in Table 2, Examples 1 to 4 including the ionic liquid and the additive of Chemical Formula 3-1 exhibited better capacity retention at room temperature compared to Comparative Example 1 without both the ionic liquid and the additive, or Comparative Examples 2 and 5 with only one of the ionic liquid or the additive. In addition, even though the ionic liquid and the additive were both included, Comparative Examples 3 including the ionic liquid with the BF₄⁻ anion or Comparative Examples 3 and 4 including the ionic liquid with the sulfonium-based cation exhibited extremely low capacity retention at room temperature, and a high SET time and DSC heating value.

Furthermore, Examples 1 to 4 exhibited lower DSC heating values than Comparative Examples 1 and 3 to 5, and particularly, Example 4 exhibited a lower DSC heating value than Comparative Examples 1 to 5, and thus, thermal stability was also excellent. In addition, the SET time of Examples 2 and 4 was lower than Comparative Examples 1 to 5, and the SET time of Examples 1 and 3 was lower than Comparative Examples 1 and 3 to 5, and thus the thermal stability was also excellent.

TABLE 3

| | | Amount | Room | | |
|---|---|---|---|---|---|
| | Amount | of additive | temperature | | DSC |
| | of ionic | of Chemical | capacity | SET | heating |
| | liquid | Formula 4-1 | retention | time | value |
| | (wt %) | (wt %) | (%) | (s) | (J/g) |
| Comparative | — | — | 84.2 | 50 | 605 |
| Example 1 | | | | | |
| Comparative | 10 | — | 84.7 | 33 | 510 |
| Example 2 | | | | | |
| Comparative | — | 0.5 | 83.9 | 52 | 601 |
| Example 6 | | | | | |
| Example 5 | 2 | 0.5 | 85.5 | 43 | 555 |
| Example 6 | 10 | 0.5 | 86.5 | 29 | 515 |
| Example 7 | 2 | 1 | 85.4 | 35 | 557 |
| Example 8 | 10 | 1 | 86.9 | 24 | 513 |

As shown in Table 3, Examples 5 to 8 including the ionic liquid and the additive of Chemical Formula 4-1 exhibited better capacity retention at room temperature compared to Comparative Example 1 without both the ionic liquid and the additive, or Comparative Examples 2 and 6 with only one of the ionic liquid and the additive. Furthermore, Examples 5 to 8 exhibited lower DSC heating values than Comparative Examples 1 and 6, and thus, thermal stability was also excellent. In addition, the SET time of Examples 6 to 8 was lower than Comparative Examples 1 and 6, and the SET time of Example 5 was lower than Comparative Examples 1 and 6, and thus, the thermal stability was also excellent.

TABLE 4

| | | Amount | Room | | |
|---|---|---|---|---|---|
| | Amount | of additive | temperature | | DSC |
| | of ionic | of Chemical | capacity | SET | heating |
| | liquid | Formula 5-1 | retention | time | value |
| | (wt %) | (wt %) | (%) | (s) | (J/g) |
| Comparative | — | — | 84.2 | 50 | 605 |
| Example 1 | | | | | |
| Comparative | 10 | — | 84.7 | 33 | 510 |
| Example 2 | | | | | |
| Comparative | — | 0.5 | 84.1 | 46 | 601 |
| Example 7 | | | | | |
| Example 9 | 2 | 0.5 | 85.7 | 41 | 560 |
| Example 10 | 10 | 0.5 | 86.0 | 31 | 514 |
| Example 11 | 2 | 1 | 86.0 | 39 | 556 |
| Example 12 | 10 | 1 | 87.2 | 25 | 507 |

As shown in Table 4, Examples 9 to 12 including the ionic liquid and the additive of Chemical Formula 5-1 exhibited better capacity retention at room temperature compared to Comparative Example 1 without both the ionic liquid and the additive, or Comparative Examples 2 and 7 with only one of the ionic liquid and the additive.

Furthermore, Examples 9 to 12 exhibited lower DSC heating values than Comparative Examples 1 and 7, and thus, thermal stability was also excellent. In addition, the SET time of Examples 9 to 12 was lower than Comparative Examples 1 and 7.

TABLE 5

| | | Amount | Room | | |
|---|---|---|---|---|---|
| | Amount | of additive | temperature | | DSC |
| | of ionic | of Chemical | capacity | SET | heating |
| | liquid | Formula 5-2 | retention | time | value |
| | (wt %) | (wt %) | (%) | (s) | (J/g) |
| Comparative | — | — | 84.2 | 50 | 605 |
| Example 1 | | | | | |
| Comparative | 10 | — | 84.7 | 33 | 510 |
| Example 2 | | | | | |
| Comparative | — | 0.75 | 84.9 | 41 | 590 |
| Example 8 | | | | | |
| Example 13 | 2 | 0.75 | 86.9 | 39 | 543 |
| Example 14 | 10 | 0.75 | 87.2 | 29 | 499 |
| Example 15 | 2 | 1 | 86.7 | 35 | 546 |
| Example 16 | 10 | 1 | 87.9 | 23 | 509 |

As shown in Table 5, Examples 13 to 16 including the ionic liquid and the additive of Chemical Formula 5-1 exhibited better capacity retention at room temperature compared to Comparative Example 1 without both the ionic liquid and the additive, or Comparative Examples 2 and 8 with only one of the ionic liquid and the additive. Furthermore, Examples 13 to 15 exhibited lower DSC heating values than Comparative Examples 1 and 8, and Example 16 exhibited a lower DSC heating value than Comparative Examples 1, 2, and 8, and thus, thermal stability was also excellent. In addition, the SET times of Examples 13 to 16 was lower than Comparative Examples 1 to 8, and the SET times of Examples 14 and 16 were lower than Comparative Example 2.

TABLE 6

| | | Amount | Room | | |
|---|---|---|---|---|---|
| | Amount | of additive | temperature | | DSC |
| | of ionic | of Chemical | capacity | SET | heating |
| | liquid | Formula 6-1 | retention | time | value |
| | (wt %) | (wt %) | (%) | (s) | (J/g) |
| Comparative | — | — | 84.2 | 50 | 605 |
| Example 1 | | | | | |
| Comparative | 10 | — | 84.7 | 33 | 510 |
| Example 2 | | | | | |
| Comparative | — | 0.5 | 84.7 | 53 | 601 |
| Example 9 | | | | | |
| Example 17 | 2 | 0.5 | 86.3 | 38 | 559 |
| Example 18 | 10 | 0.5 | 86.8 | 27 | 515 |
| Example 19 | 2 | 1 | 86.7 | 39 | 561 |
| Example 20 | 10 | 1 | 87.6 | 26 | 518 |

As shown in Table 6, Examples 17 to 20 including the ionic liquid and the additive of Chemical Formula 6-1 exhibited better capacity retention at room temperature than Comparative Example 1 without both the ionic liquid and the additive or Comparative Examples 2 and 9 with only one of the ionic liquid and the additive. Furthermore, Examples 17 to 20 exhibited lower DSC heating values than Comparative Examples 1 and 9, which indicated better thermal stability. In addition, the SET times of Examples 18 and 20 were lower than Comparative Examples 1, 2, and 9, and the SET times of Examples 17 and 19 were lower than Comparative Examples 1 and 9.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. An electrolyte for a rechargeable lithium battery, comprising:
a non-aqueous organic solvent;
a lithium salt;
an ionic liquid comprising a cation represented by Chemical Formula 1 and an anion represented by Chemical Formula 2; and
an additive comprising at least one compounds represented by Chemical Formulas 3 to 6: 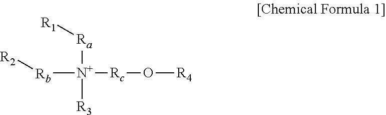
wherein R1 to R4 are the same or different, and are a substituted or unsubstituted C1 to C3 alkyl group,
Ra, Rb, Rc, and Rd are the same or different, and are a substituted or unsubstituted C1 to C6 alkylene group;
R5-SO2-N—SO2-R6R5-SO2-N—SO2-R6 [Chemical Formula 2]
wherein R₅ and R₆ are a fluoroalkyl group including at least one F); 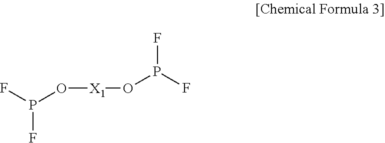
(wherein X₁ is a substituted or unsubstituted C1 to C3 alkylene group or (−C2H4-O—C2H4-)n1, and n1 is an integer ranging from 1 to 10; 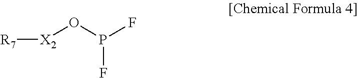
wherein X2 is a substituted or unsubstituted C1 to C2 alkylene group or or (—C2H4-O—C2H4-)n2, and n2 is an integer ranging from 1 to 10, and
R7 is —CN, —N═C═O, —N═C═S, —OSO2CH3, —OSO2C2H5, —OSO₂F, or —OSOCF3; 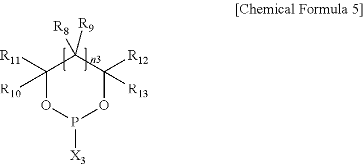
wherein
X3 is a fluoro group, a chloro group, a bromo group, or an iodo group,
R8 to R13 are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group or a substituted or unsubstituted C2 to C20 heteroaryl group, and
n3 is an integer of 0 or 1; and 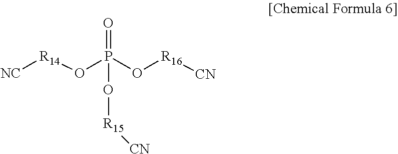
wherein, R14 to R16 are the same or different, and are a substituted or unsubstituted C1 to C10 alkylene group, a substituted or unsubstituted C3 to C30 cycloalkylene group, a substituted or unsubstituted C6 to C30 arylene group, or a substituted or unsubstituted C2 to C30 heteroarylene group.

2. The electrolyte for a rechargeable lithium battery of claim 1, wherein an amount of the ionic liquid is 0.05 wt % to 30 wt % based on the total, 100 wt %, of the electrolyte.

3. The electrolyte for a rechargeable lithium battery of claim 1, wherein an amount of the additive is 0.05 wt % to 10 wt % based on the total, 100 wt %, of the electrolyte.

4. The electrolyte for a rechargeable lithium battery of claim 1, wherein an amount of the additive is 0.05 wt % to 8 wt % based on the total, 100 wt %, of the electrolyte.

5. The electrolyte for a rechargeable lithium battery of claim 1, wherein in Chemical Formula 4, R7 is —CN.

6. The electrolyte for a rechargeable lithium battery of claim 1, wherein in Chemical Formula 5, X3 is F.

7. The electrolyte for a rechargeable lithium battery of claim 1, wherein the compound of Chemical Formula 5 is represented by Chemical Formula 5a or Chemical Formula 5b: 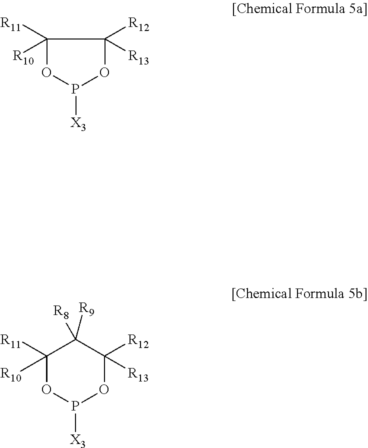
wherein
X3 is a fluoro group, a chloro group, a bromo group, or an iodo group,
R8 to R13 are the same or different, and are hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

8. A rechargeable lithium battery, comprising:
a negative electrode;
a positive electrode; and
the electrolyte of claim 1.
